(19) United States
(12) Patent Application Publication
(10) Pub. No.: US 2015/0188438 A1
(43) Pub. Date: Jul. 2, 2015

(54) POWER CONVERSION APPARATUS FOR VEHICLE AND METHOD FOR CONTROLLING THE SAME

(71) Applicant: HYUNDAI MOBIS CO., LTD., SEOUL (KR)

(72) Inventor: Bumyul Kim, Yongin-si (KR)

(73) Assignee: HYUNDAI MOBIS CO., LTD., SEOUL (KR)

(21) Appl. No.: 14/250,281

(22) Filed: Apr. 10, 2014

(30) Foreign Application Priority Data
Dec. 31, 2013 (KR) 10-2013-0168239

(51) Int. Cl. H02M 3/335; B60L 11/18

(52) U.S. Cl. CPC H02M 3/33507; B60L 11/1851

(57) ABSTRACT

A power conversion apparatus may include an output circuit unit configured to generate an output power, a first controller configured to sense the output power to compare the sensed output power with a reference value and to perform a switching control for generating a boosted power, a first-stage input unit configured to receive a battery power and to generate a boosted power according to the switching control, a second-stage input unit configured to convert the boosted power into another power, and a conversion unit configured to, perform a conversion operation on the other power for the sake of the output power.

### CROSS-REFERENCE TO RELATED APPLICATION

This application claims the benefit of priority to Korean Patent Application No. 10-2013-0168239 filed on Dec. 31, 2013, the entire contents of which are incorporated herein by reference in its entirety.

### TECHNICAL FIELD

Exemplary embodiments of the present invention relate to a power conversion apparatus for a vehicle, and particularly, to a power conversion apparatus for a vehicle having a two-stage input circuit and a method for controlling the same.

In addition, exemplary embodiments of the present invention relate to a power conversion apparatus for a vehicle which controls a fixed duty after boosting an input voltage from a high-voltage battery to a predetermined voltage, and a method for controlling the same.

In addition, exemplary embodiments of the present invention relate to a power conversion apparatus for a vehicle which reduces loss and has an improved efficiency by changing input-stage-side and output-stage-side circuits to switching elements, and a method for controlling the same.

### BACKGROUND

In general, a green vehicle has power sources which include an engine and/or a driving motor driven by the power of a battery. Such a green vehicle can improve fuel efficiency through the power assistance of the motor, which operates by the voltage of the battery, on starting or accelerating of the vehicle by applying a structure in which the power sources are appropriately combined to the front wheel thereof.

The green vehicle has a power conversion apparatus, i.e. a low DC/DC converter (LDC), which rectifies the power of a high-voltage battery to make direct current.

The power conversion apparatus switches general direct current (DC) to produce alternating current (AC), and boosts or drops the alternating current using a coil, a transformer, a capacitor, or the like. Thereafter, the power conversion apparatus functions to again rectify the boosted or dropped alternating current to produce direct current (DC), and to supply electricity according to voltages used in the respective electronic devices.

Such a power conversion apparatus is illustrated in FIG. 1. Referring to FIG. 1, a high-voltage input stage 110, a full-bridge circuit unit 120, a transformer 140, and an output stage 160 are included.

However, the case of such a configuration, the power conversion apparatus must change power circuit components (e.g. a driving driver circuit, a transformer, a rectifying diode, and the like) according to the specification of the input voltage of a high-voltage battery. In detail, high-voltage batteries of approximately 180-310 V, approximately 200-410 V, approximately 170-280 V, and approximately 132-206 are used according to types of vehicles, so that the specifications of high-voltage batteries are mutually different depending on types of vehicles. Accordingly, power circuit components also are divided into two types and are manufactured and/or managed. Thus, the cost of materials and/or the management expenses increase.

Also, in the case of the conventional power conversion apparatus, when a high-voltage battery is at a low voltage, input current increases, and power conversion loss increases, so that a range in which the efficiency is approximately 90% or less is generated. Since most of loss appears as heat when current flows, it is necessary to reduce current so as to reduce loss to be generated.

Also, in the conventional power conversion apparatus, large loss occurs at an output stage, which is mainly configured with a rectifying diode. In detail, loss, when current flows through a diode, corresponds to 50% of the loss occurring in the power conversion apparatus, which corresponds to approximately 2% of the efficiency of the power conversion apparatus. The loss of a power conversion apparatus is defined as follows:

P=Vd·I.

Here, “Vd” represents the forward voltage drop of a diode, and “I” represents current.

### SUMMARY

An embodiment of the present invention is directed to a power conversion apparatus for a vehicle having an improved efficiency in which components of a power circuit are not required to be changed depending on the input voltage specification of a high-voltage battery and can be identically applied and used in common, and a method for controlling the same.

Another embodiment of the present invention is directed to a power conversion apparatus for a vehicle having an improved power convention efficiency by reducing power conversion loss, and a method for controlling the same.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

Provided is a power conversion apparatus for a vehicle having an improved efficiency in which components of a power circuit are not required to be changed depending on the input voltage specification of a high-voltage battery and can be identically applied and used in common.

In accordance with an embodiment of the present invention, a power conversion apparatus includes: an output circuit unit configured to generate an output power; a first controller configured to sense the output power, to compare the sensed output power with a reference value, and to perform a switching control for generating a boosted power; a first-stage input unit configured to receive a battery power and to generate a boosted power according to the switching control; a second-stage input unit configured to convert the boosted power into another power; and a conversion unit configured to perform a conversion operation on the other power for the sake of the output power.

In this case, the first-stage input unit may generate the boosted power using a boosting manner.

In addition, the first-stage input unit may include: an inductor; a first power switching element configured to store the battery power in the inductor for the boosted power; and a second power switching element configured to pass or block the boosted power.

In addition, the boosted power may be a sum of energy stored in the inductor and the battery power.

In addition, the first power switching element and the second power switching element may be configured with metal-oxide-semiconductor field-effect transistors (MOSFETs).

In addition, the second-stage input unit may correspond to a full-bridge circuit, and may be configured with a metal-oxide-semiconductor field-effect transistor (MOSFET).

In addition, the second-stage input unit may use a fixed duty value.

In addition, the output circuit unit may correspond to a synchronous rectifying circuit synchronized with the second-stage input unit.

In addition, the output circuit unit may be configured with a metal-oxide-semiconductor field-effect transistor (MOSFET).

In addition, the apparatus may further include a second controller which is configured to control the output circuit unit or the second-stage input unit to be switched on or off for synchronization.

In addition, the first controller may include: a sensing unit configured to sense the output power; a comparator configured to compare the sensed output power with a reference value; and an on/off operating unit configured to perform a switching control according to a result of the comparison.

In accordance with another embodiment of the present invention, a method for controlling a power conversion apparatus for a vehicle includes: sensing an output power; comparing the sensed output power with a reference value; generating, by a first-stage input unit, a boosted power by performing a switching control and by receiving a battery power according to a comparison result; converting, by a second-stage input unit, a boosted power to generate a different power; and generating, by an output circuit unit, the output power from the different power.

In this case, in generating a boosted power, a boosting manner may be used to generate the boosted power.

In addition, generating a boosted power may include: storing a battery power in an inductor using a first power switching element; and passing or blocking the boosted power using a second switch.

In addition, the comparing may include: performing a switching control to generate a boosted power when the output power is less than the reference value as a comparison result; and performing a switching control not to generate a boosted power when the output power meets the reference value as a comparison result.

### BRIEF DESCRIPTION OF THE DRAWINGS

FIG. 1 is a view illustrating the configuration of a conventional power conversion apparatus;

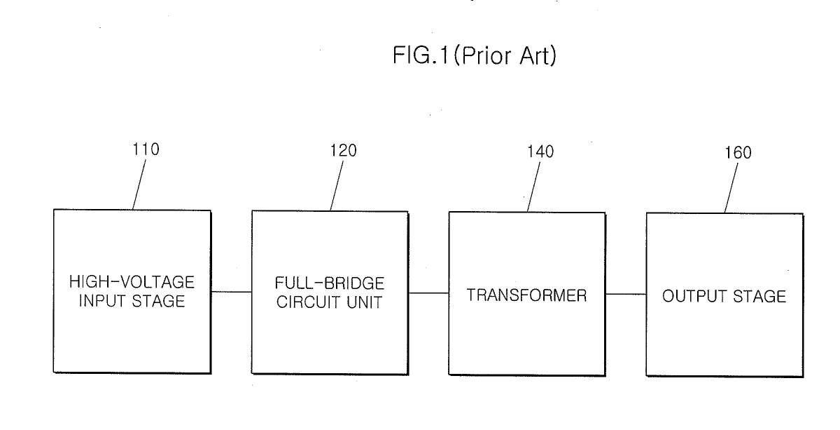

FIG. 2 is a block diagram illustrating the circuit of a power conversion apparatus in accordance with an embodiment of the present invention;

FIG. 3 is a circuit diagram showing an example capable of being implemented as the power conversion apparatus shown in FIG. 2;

FIG. 4 is a block diagram illustrating the circuit of the first controller shown in FIG. 2; and

FIG. 5 is a flowchart showing a control procedure of the power conversion apparatus in accordance with an embodiment of the present invention.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Like reference signs are used for like components in describing each drawing.

Although the terms like a first, a second, and the like are used to describe various components, the components should not be limited by the terms. The terms may be used for the purpose of distinguishing one component from another.

For example, a first component may be named a second component and similarly, a second component may be named a first component without departing from the scope of right of the present invention. The term and/or includes a combination of a plurality of related described items or any of the plurality of related described items.

Unless being otherwise defined, all terms used herein that include technical or scientific terms have the same meaning as those generally understood by those skilled in the art.

The terms, such as those defined in dictionaries generally used should be construed to have meaning matching that having in context of the related art and are not construed as ideal or excessively perfunctory meaning unless being clearly defined in this application.

Hereinafter, a power conversion apparatus for a vehicle having an improved efficiency, and a method for controlling the same according to the present invention will be described below with reference to the accompanying drawings through exemplary embodiments.

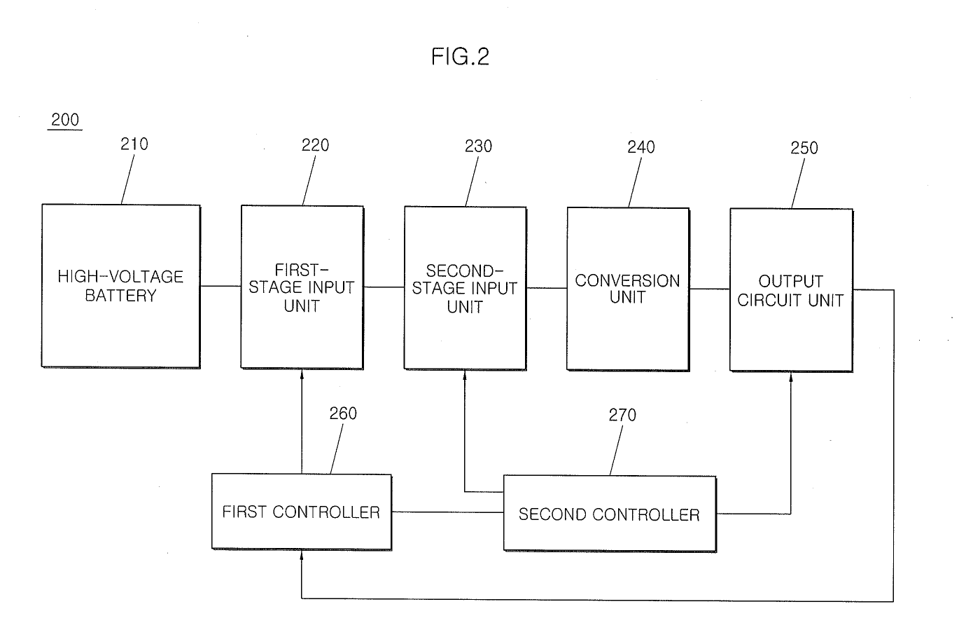

FIG. 2 is a block diagram illustrating the circuit of a power conversion apparatus 200 in accordance with an embodiment of the present invention. Referring to FIG. 2, the power conversion apparatus 200 for a vehicle may be configured to include: an output circuit unit 250 for generating an output power; a first controller 260 for sensing the output power, comparing the sensed output power with a reference value, and performing a switching control to generate a boosted power; a first-stage input unit 220 for receiving a battery power and generating a boosted power according to the switching control; a second-stage input unit 230 for converting the boosted power into another power; and a conversion unit 240 for performing a conversion operation on the other power for the sake of the output power.

The first-stage input unit 220 may receive a power from a high-voltage battery 210 and boost the received power. The boosting may be achieved in a boosting scheme, but the present invention is not limited thereto. Otherwise, a buck scheme, a buck-boosting scheme, or the like may be used.

The high-voltage battery 210 may be configured with battery cells (not shown) electrically coupled in series and/or in parallel with each other, wherein the battery cell may be a battery, such as a nickel-metal battery or a lithium-ion battery, for a green vehicle. The high-voltage battery 210 outputs the power thereof.

Here, the green vehicle may be, for example, an electric vehicle (EV), a hybrid electric vehicle (HEV), a plug-in hybrid electric vehicle (PHEV), a fuel cell vehicle, or the like.

The second-stage input unit 230 may function to rectify the boosted power from alternating current to direct current. To this end, a full-bridge circuit may be used, but the present invention is not limited thereto. Otherwise, a half-bridge circuit may be used. In addition, the second-stage input unit 230 may function to convert alternating current to direct current, even with respect to a non-boosted power.

The first-stage input unit 220 and the second-stage input unit 230 allows a two-stage input stage to be configured. Accordingly, an input voltage from the high-voltage battery 210 is boosted to a predetermined voltage by the first-stage input unit 220, and is then controlled to have a fixed duty by the second-stage input unit 230. The boosting by the first-stage input unit 220 reduces a current value, so that loss is reduced and the efficiency increases.

The conversion unit 240 converts the rectified power into another power. For example, the conversion unit 240 may be a transformer, and may be configured to drop a direct current power to a lower direct current power.

The output circuit unit 250 may generate an output power using the converted power. For example, the output circuit unit 250 may rectify the power dropped by the conversion unit 240 to a direct current (DC) power, and output the rectified power to an output terminal thereof.

The first controller 260 may sense an output voltage outputted through the output terminal of the output circuit unit 250, compare the sensed voltage with a reference value, e.g. a reference voltage, and generate a first switching control signal to turn on or off the first-stage input unit 220 and/or a control ON signal for the control of a second controller 270.

When the second controller 270 receives an ON signal from the first controller 260, the second controller 270 may generate a second switching control signal for turning on or off the second-stage input unit 230 and/or the output circuit unit 250.

The second controller 270 may be configured with a direct current-direct current (DC-DC) controller. In addition, after transmitting a second control signal to the second-stage input unit 230, the second controller 270 may transmit an ON signal to the first controller 260.

In addition, when the second controller 270 receives an ON signal from the first controller 260, the second controller 270 performs a synchronization operation by turning on or off the second-stage input unit 230 and/or the output circuit unit 250.

The first-stage input unit 220 and the second-stage input unit 230 constitute a two-stage input circuit, and may function to boost an input power according to a first switching control signal of the first controller 260. In detail, the two-stage input circuit may store a power energy inputted from the high-voltage battery 210 when the first switching control signal is in an ON state, and may add and boost a stored energy and a battery power inputted from the high-voltage battery 210.

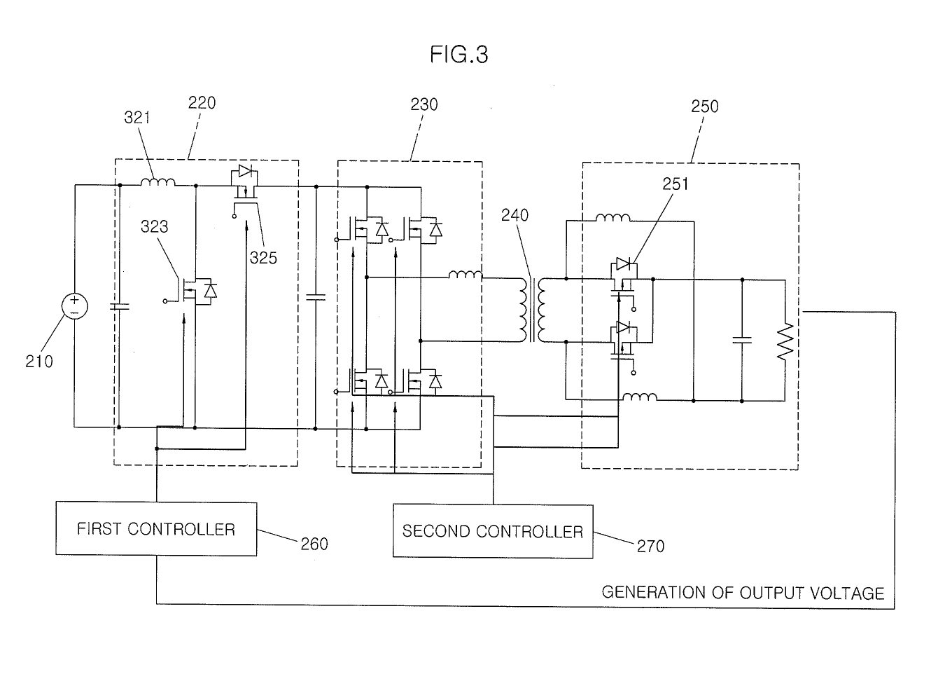

FIG. 3 is a circuit diagram showing an example capable of being implemented as the power conversion apparatus 200 shown in FIG. 2. Referring to FIG. 3, the first-stage input unit 220 may be configured to include: an inductor 321 for storing a battery power inputted from the high-voltage battery 210; a second power switching element 325 for adding and boosting the power stored in the inductor 321 and a newly-received battery power and passing the boosted power therethrough; and a first power switching element 323 for being turned on or off by the first controller 260 to either store the power of the inductor 321 or to pass the boosted power through the second power switching element 325.

In detail, when a first switching control signal is inputted by the first controller 260, the first power switching element 323 is turned on, and the second power switching element 325 is turned off. In this case, a battery power from the high-voltage battery 210 is stored in the inductor 321.

Thereafter, when a predetermined time has elapsed, the first switching control signal is again inputted, so that the first power switching element 323 is switched to an off state, and the second power switching element 325 is switched to an on state. In this case, a battery power newly inputted from the high-voltage battery 210 and the power stored in the inductor 321 are added to generate a boosted power. The boosted power is transmitted to the second-stage input unit 230 through the second power switching element 325.

The power switching element 323 may be configured with a field effect transistor (FET), a bipolar junction transistor (BJT) for power, a metal-oxide-semiconductor field-effect transistor (MOSFET), an isolated-gate bipolar transistor (IGBT), or the like.

The second-stage input unit 230 may function to rectify a boosted power, which is transmitted from the first-stage input unit 220, using a fixed duty. To this end, the second-stage input unit 230 also may be configured with power switching elements. The power switching elements are on/off controlled by the second controller 270.

The output circuit unit 250 is turned on or off at the same time as the second-stage input unit 230 in such a manner as to be synchronized with the ON/OFF of the second-stage input unit 230, thereby rectifying a power dropped by the conversion unit 240 to a DC power. To this end, the output circuit unit 250 also may be configured with power switching elements 251. MOSFETs may be used as the power switching elements 251, but the present invention is not limited thereto.

Similarly to the second-stage input unit 230, the output circuit unit 250 may be turned on or off by a control signal of the second controller 270.

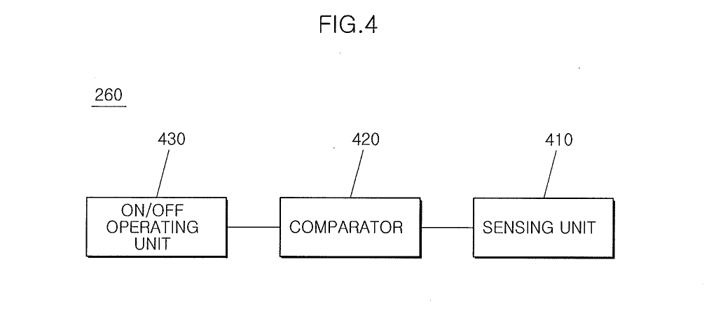

FIG. 4 is a block diagram illustrating the circuit of the first controller 260 shown in FIG. 2. Referring to FIG. 4, the first controller 260 may be configured to include: a sensing unit 410 for sensing the output power; a comparator 420 for comparing the sensed output power with a reference value; and an on/off operating unit 430 for performing a switching control according to a result of the comparison.

The sensing unit 410 may be configured with a current transformer (CT), a voltage sensor, and a current sensor of the output circuit unit 250 shown in FIG. 2.

The comparator 420 may have a preset reference value, and may function to compare the output power sensed through the sensing unit 410 with the reference value, and to determine whether or not boosting is required.

The on/off operating unit 430 may function to turn on/off the power switching elements 323 and 325 configured in the first-stage input unit 220.

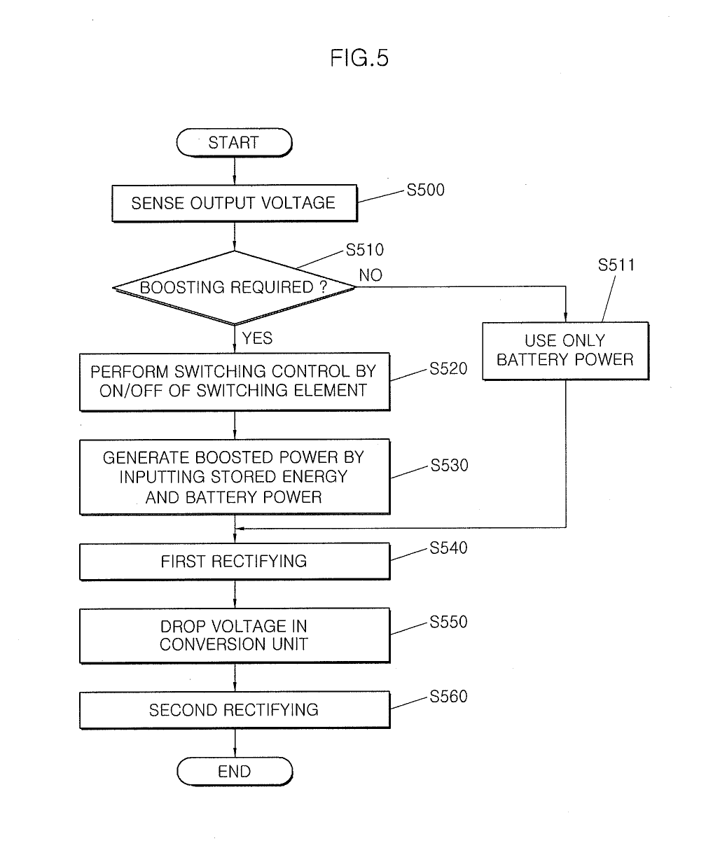

FIG. 5 is a flowchart showing a control procedure of the power conversion apparatus 200 in accordance with an embodiment of the present invention. Referring to FIG. 5, an output power outputted from the output circuit unit 250 shown in FIG. 2 is sensed in step S500.

The sensed output power is compared with a reference value, and it is determined whether boosting is required in step S510. When the output power does not reach the reference value and thus boosting is required as a result of the comparison, the first-stage input unit is on/off controlled through a switching control in step S520. In detail, a power switching element configured in the first-stage input unit 220 shown in FIG. 2 is on/off controlled at a predetermined interval of time to store a power in an energy storage element, e.g. an inductor.

Then, the stored power and a battery power newly inputted from the high-voltage battery 210 shown in FIG. 2 are added to generate a boosted power in step S530.

In contrast, when the sensed output power meets the reference value in step S510, a boosted power is not required, and in this case, only the battery power received from the high-voltage battery 210 is used in step S511.

The boosted power or the non-boosted power is first rectified using a fixed duty in the second-stage input unit 230 shown in FIG. 2 in step S540, and is then dropped by the conversion unit 240 in step S550.

The dropped power is secondly rectified by the output circuit unit 250 to be transformed into an output power in step S560.

In accordance with the exemplary embodiments of the present invention, since two-stage input circuits are applied, the components of a power circuit are not required to be changed depending on the input voltage specification of a high-voltage battery and can be identically applied and used in common, so that development expenses and management expenses can be reduced.

In addition, in accordance with the exemplary embodiments of the present invention, since the boosting by a first input stage reduces a current value, loss is reduced, so that the efficiency can increase.

In addition, in accordance with the exemplary embodiments of the present invention, since a switching element is applied to the first input stage, the current-flowing loss is reduced, so that the loss is further reduced, and the efficiency can increase.

In addition, in accordance with the exemplary embodiments of the present invention, since a switching element is applied to an output stage, loss is reduced on rectifying, so that the efficiency can increase.

In addition, in accordance with the exemplary embodiments of the present invention, the application of the two-stage input circuits and switching elements improves the overall efficiency of the power conversion apparatus, wherein the maximum efficiency is improved from approximately from 92% to 96%, and the average efficiency is improved from approximately from 90% to 95%.

While the present invention has been described with respect to the specific embodiments, it will be apparent to those skilled in the art that various changes and modifications may be made without departing from the spirit and scope of the invention as defined in the following claims.

What is claimed is:

1. A power conversion apparatus comprising:
an output circuit unit configured to generate output power;
a first controller configured to acquire a value representing the output power, to compare the acquired value of the output power with a reference value, and to perform a switching control for generating boosted power;
a first-stage input unit configured to receive battery power and to generate boosted power according to the switching control;
a second-stage input unit configured to convert the boosted power or the battery power into another power; and
a conversion unit configured to perform a conversion operation on the other power for the sake of the output power.

2. The apparatus of claim 1, wherein the first-stage input unit generates the boosted power using a boosting manner.

3. The apparatus of claim 2, wherein the first-stage input unit comprises: an inductor; a first power switching element configured to store the battery power in the inductor for the boosted power; and a second power switching element configured to pass or block the boosted power.

4. The apparatus of claim 3, wherein the boosted power is a sum of energy stored in the inductor and the battery power.

5. The apparatus of claim 3, wherein the first power switching element and the second power switching element are configured with metal-oxide-semiconductor field-effect transistors (MOSFETs).

6. The apparatus of claim 1, wherein the second-stage input unit corresponds to a full-bridge circuit, and is configured with a metal-oxide-semiconductor field-effect transistor (MOSFET).

7. The apparatus of claim 6, wherein the second-stage input unit uses a fixed duty value.

8. The apparatus of claim 1, wherein the output circuit unit corresponds to a synchronous rectifying circuit synchronized with the second-stage input unit, and is configured with a metal-oxide-semiconductor field-effect transistor (MOSFET).

9. The apparatus of claim 8, further comprising a second controller which is configured to control the output circuit unit or the second-stage input unit to be switched on or off for synchronization.

10. The apparatus of claim 1, wherein the first controller comprises: a sensing unit configured to acquire the value representing the output power; a comparator configured to compare the acquired value of the output power with a reference value; and an on/off operating unit configured to perform a switching control according to a result of the comparison.

11. A method of operating a power conversion apparatus of a vehicle, comprising:
acquiring a value representing output power which is supplied to an electric load in the vehicle;
comparing the acquired value of the output power with a reference value to determine if battery power from a battery is to be boosted;
when determined that the battery power is to be boosted,
supplying the battery power to a first-stage input unit;
generating, by the first-stage input unit, boosted power by performing a switching control to boost the battery power;
supplying the boosted power to a second-stage input unit;
converting, by the second-stage input unit, the boosted power into converted power; and
converting, by an output circuit unit, the converted power into the output power,
when determined that the battery power is not to be boosted,
supplying the battery power to the second-stage input unit;
converting, by the second-stage input unit, the battery power into converted power; and
converting, by an output circuit unit, the converted power to the output power.

12. The method of claim 11, wherein, in the generating a boosted power, a boosting manner is used to generate the boosted power.

13. The method of claim 12, wherein the generating a boosted power comprises:
storing the battery power in an inductor using a first power switching element; and
passing or blocking the boosted power using a second switch.

14. The method of claim 13, wherein the boosted power is a sum of energy stored in the inductor and the battery power.

15. The method of claim 13, wherein the first power switching element and the second power switching element are configured with metal-oxide-semiconductor field-effect transistors (MOSFETs).

16. The method of claim 11, wherein the second-stage input unit comprises a full-bridge circuit, and is configured with a metal-oxide-semiconductor field-effect transistor (MOSFET).

17. The method of claim 16, wherein the second-stage input unit uses a fixed duty value.

18. The method of claim 11, wherein the output circuit unit corresponds to a synchronous rectifying circuit synchronized with the second-stage input unit, and is configured with a metal-oxide-semiconductor field-effect transistor (MOSFET).

19. The method of claim 18, wherein the synchronization is achieved by controlling switching of the output circuit unit or the second-stage input unit using a second controller.

20. The method of claim 11, wherein the comparing comprises:
performing a switching control to generate a boosted power when the output power is less than the reference value as a comparison result; and
performing a switching control not to generate a boosted power when the output power meets the reference value as a comparison result.
